(19) United States
(12) Patent Application Publication
(10) Pub. No.: US 2025/0181243 A1
(43) Pub. Date: Jun. 5, 2025

(54) PATH DEVICE SELECTION METHOD AND APPARATUS, AND ELECTRONIC DEVICE AND READABLE STORAGE MEDIUM

(71) Applicant: SUZHOU METABRAIN INTELLIGENT TECHNOLOGY CO., LTD., Suzhou, Jiangsu (CN)

(72) Inventors: Zhenguang ZHANG, Suzhou, Jiangsu (CN); Yijie WANG, Suzhou, Jiangsu (CN)

(21) Appl. No.: 18/869,558

(22) PCT Filed: Jun. 29, 2023
(86) PCT No.: PCT/CN2023/104021

§ 371 Date: Nov. 26, 2024

(30) Foreign Application Priority Data
Nov. 29, 2022 (CN) 202211508414.6

(51) Int. Cl. G06F 3/06

(52) U.S. Cl. CPC G06F 3/0611; G06F 3/0635; G06F 3/067

(57) ABSTRACT

A method for selecting a path device includes: for each of the path devices, collecting an unfinished Input/Output (IO) size and corresponding IO time consumption of the storage nodes of various types corresponding to the path device; according to the unfinished IO size and the IO time consumption, fitting a mapping relationship between the unfinished IO size and the IO time consumption of the storage nodes of the various types; when a new IO occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; comparing the estimated time consumption, and selecting a candidate path device corresponding to shortest estimated time consumption as a target path device.

### CROSS-REFERENCE TO RELATED APPLICATION

The present application claims the priority of the Chinese patent application filed on Nov. 29^{th}, 2022 before the CNIPA, China National Intellectual Property Administration with the application number of 202211508414.6 and the title of “PATH DEVICE SELECTION METHOD AND APPARATUS, AND ELECTRONIC DEVICE AND READABLE STORAGE MEDIUM”, which is incorporated herein in its entirety by reference.

### FIELD

The present application relates to the technical field of terminals and more particularly, to a method for selecting a path device, an apparatus for selecting a path device, an electronic device and a non-transitory computer-readable storage medium.

### BACKGROUND

In the prior art, the selection of the optimal path is usually achieved through multi-path software. Based on the application of the multi-path software, when any path between the server and the storage device fails, an IO (Input/Output) request may be sent through other paths to avoid data access interruption between the server and the storage device caused by a single point of failure. In addition, the IO request from the server to the storage device may be sent concurrently through multiple paths to improve the IO throughput of the server data access.

However, the current path selection strategy of multi-path software is not comprehensive enough. In the process of path selection, only the master node where the IO is located is usually selected, without considering the slave nodes and other nodes. In many scenarios, there are already many unfinished IOs on the path of the master node, while the slave nodes and the other nodes are in an idle state, which may easily lead to an increase in path selection time and low IO efficiency. If the slave nodes or the other nodes are selected at this time, it will be more time-saving and efficient.

### SUMMARY

Some embodiments of the present application provide a method and apparatus for selecting a path device, an electronic device and a computer-readable storage medium, to solve or partially solve the problem of increased selection time of the path device and low IO efficiency caused by only selecting the master node where the IO is located, without considering the slave nodes and the other nodes during a selecting process of the path devices.

Some embodiments of the present application disclose a method for selecting a path device, relating to storage nodes, the storage nodes have corresponding path devices, and the method comprises:
for each of the path devices, collecting an unfinished Input/Output size and corresponding Input/Output time consumption of the storage nodes of various types corresponding to the path device;
according to the unfinished Input/Output size and the Input/Output time consumption, fitting a mapping relationship between the unfinished Input/Output size and the Input/Output time consumption of the storage nodes of the various types;
when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; and
comparing the estimated time consumption, and selecting a candidate path device corresponding to shortest estimated time consumption as a target path device.

In some embodiments, the storage nodes are located in a storage system, and before the step of, for each of the path devices, collecting the unfinished Input/Output size and the corresponding Input/Output time consumption of the storage nodes of the various types corresponding to the path device, the method further comprises:
in response to a creation instruction for a server and a volume of the storage node, mapping the volume to the server, wherein the volume is a temporary directory in a lifecycle of the storage node;
in response to a link creation instruction of the server and the storage system, connecting the server and the storage system through a link, wherein the link is a path from the server to the storage node of the storage system corresponding to the volume.

In some embodiments, the method further includes:
when the volume is mapped to the server, mapping the link corresponding to the volume of the storage node to the path device, wherein a quantity of links is the same as a quantity of path devices corresponding to the volume of the storage node.

In some embodiments, the storage node corresponds to a plurality of path devices, the plurality of path devices are located on the server, wherein the plurality of path devices are aggregated into one multi-path device.

In some embodiments, the volume is on the storage system, and the volume is divided into a plurality of segments according to a preset segment granularity.

In some embodiments, a plurality of Input/Outputs form an Input/Output group, a plurality of storage nodes in the Input/Output group are divided into a plurality of mirroring relationships, a quantity of the mirroring relationships is the same as a quantity of the storage nodes in the Input/Output group and a quantity of the segments, and the mirroring relationships correspond to the segments.

In some embodiments, the step of determining the target storage node and the candidate path device corresponding to the target storage node comprises:
according to a starting position of the new Input/Output, determining a segment corresponding to the new Input/Output;
according to the segment corresponding to the new Input/Output, determining a mirroring relationship corresponding to the segment; and
determining the target storage node through the mirroring relationship corresponding to the segment, to determine the candidate path device corresponding to the target storage node.

In some embodiments, the unfinished Input/Output size comprises an unfinished Input/Output size existing in the storage node and an Input/Output size when the new Input/Output occurs.

In some embodiments, types of the storage nodes comprise a master node type, and the step of, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the master node type; and
according to the unfinished Input/Output size and the Input/Output time consumption, fitting a mapping relationship between the unfinished Input/Output size and the Input/Output time consumption of the storage node of the master node type.

In some embodiments, types of the storage nodes comprise a slave node type, and the step of, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the slave node type; and
according to the unfinished Input/Output size and the Input/Output time consumption, fitting a mapping relationship between the unfinished Input/Output size and the Input/Output time consumption of the storage node of the slave node type.

In some embodiments, types of the storage nodes comprise an other-node type, and the step of, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the other-node type; and
according to the unfinished Input/Output size and the Input/Output time consumption, fitting a mapping relationship between the unfinished Input/Output size and the Input/Output time consumption of the storage node of the other-node type.

In some embodiments, the mapping relationship is used for calculating the estimated time consumption for sending the new Input/Output from the candidate path device to the target storage node.

In some embodiments, the step of, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining a master node and a candidate path device corresponding to the master node; and
according to the mapping relationship corresponding to the master node and the candidate path device, calculating estimated time consumption for sending the new Input/Output from the candidate path device to the master node.

In some embodiments, the step of, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining a slave node and a candidate path device corresponding to the slave node; and
according to the mapping relationship corresponding to the slave node and the candidate path device, calculating estimated time consumption for sending the new Input/Output from the candidate path device to the slave node.

In some embodiments, the step of, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining other nodes and candidate path devices corresponding to the other nodes; and
according to the mapping relationship corresponding to the other nodes and the candidate path devices, calculating estimated time consumption for sending the new Input/Output from the candidate path devices to the other nodes.

In some embodiments, the step of comparing the estimated time consumption, and selecting the candidate path device corresponding to the shortest estimated time consumption as the target path device comprises:
comparing the estimated time consumption for sending the new Input/Output from the candidate path device to the master node, estimated time consumption for sending the new Input/Output from the candidate path device to a slave node, and estimated time consumption for sending the new Input/Output from the candidate path devices to other nodes, to obtain the shortest estimated time consumption; and
selecting the candidate path device corresponding to the shortest estimated time consumption as the target path device.

In some embodiments, after the step of, comparing the estimated time consumption, and selecting the candidate path device corresponding to the shortest estimated time consumption as the target path device, the method further comprises:
sending the new Input/Output to the target storage node through the target path device.

Some embodiments of the present application further disclose an apparatus for selecting a path device, relating to storage nodes, the storage nodes have corresponding path devices, and the apparatus comprises:
a data collection module configured for, for each of the path devices, collecting an unfinished Input/Output size and corresponding Input/Output time consumption of the storage nodes of various types corresponding to the path device;
a mapping relationship fitting module configured for, according to the unfinished Input/Output size and the Input/Output time consumption, fitting a mapping relationship between the unfinished Input/Output size and the Input/Output time consumption of the storage nodes of the various types;
an estimated time consumption calculation module configured for, when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; and
a target path device selection module configured for comparing the estimated time consumption, and selecting a candidate path device corresponding to shortest estimated time consumption as a target path device.

In some embodiments, types of the storage nodes comprise a master node type, and the mapping relationship fitting module is configured for:
collecting an unfinished Input/Output size and corresponding Input/Output time consumption of a storage node of the master node type; and
according to the unfinished Input/Output size and the Input/Output time consumption, fitting a mapping relationship between the unfinished Input/Output size and the Input/Output time consumption of the storage node of the master node type.

In some embodiments, types of the storage nodes comprise a slave node type, and the mapping relationship fitting module is configured for:
collecting an unfinished Input/Output size and corresponding Input/Output time consumption of a storage node of the slave node type; and
according to the unfinished Input/Output size and the Input/Output time consumption, fitting a mapping relationship between the unfinished Input/Output size and the Input/Output time consumption of the storage node of the slave node type.

In some embodiments, types of the storage nodes comprise an other-node type, and the mapping relationship fitting module is configured for:
collecting an unfinished Input/Output size and corresponding Input/Output time consumption of a storage node of the other-node type; and
according to the unfinished Input/Output size and the Input/Output time consumption, fitting a mapping relationship between the unfinished Input/Output size and the Input/Output time consumption of the storage node of the other-node type.

In some embodiments, the estimated time consumption calculation module is configured for:
when the new Input/Output occurs, determining a master node and a candidate path device corresponding to the master node; and
according to the mapping relationship corresponding to the master node and the candidate path device, calculating estimated time consumption for sending the new Input/Output from the candidate path device to the master node.

In some embodiments, the estimated time consumption calculation module is configured for:
when the new Input/Output occurs, determining a slave node and a candidate path device corresponding to the slave node; and
according to the mapping relationship corresponding to the slave node and the candidate path device, calculating estimated time consumption for sending the new Input/Output from the candidate path device to the slave node.

In some embodiments, the estimated time consumption calculation module is configured for:
when the new Input/Output occurs, determining other nodes and candidate path devices corresponding to the other nodes; and
according to the mapping relationship corresponding to the other nodes and the candidate path devices, calculating estimated time consumption for sending the new Input/Output from the candidate path devices to the other nodes.

In some embodiments, the target path device selection module is configured for:
comparing the estimated time consumption for sending the new Input/Output from the candidate path device to the master node, estimated time consumption for sending the new Input/Output from the candidate path device to a slave node, and estimated time consumption for sending the new Input/Output from the candidate path devices to other nodes, to obtain the shortest estimated time consumption; and
selecting the candidate path device corresponding to the shortest estimated time consumption as the target path device.

Some embodiments of the present application further disclose an electronic device, comprising a processor, a communication interface, a memory, and a communication bus, wherein the processor, the communication interface, and the memory communicate with each other through the communication bus;
the memory is used for storing a computer program; and
the processor is used for, when executing the program stored on the memory, implementing the method for selecting the path device described above.

Some embodiments of the present application further disclose a non-transitory computer-readable storage medium, storing instructions that, when executed by one or more processors, cause the processors to perform the method for selecting the path device described above.

Some embodiments of the present application include the following advantages:

In some embodiments, the method for selecting a path device relates to storage nodes, the storage nodes have corresponding path devices. For each of the path devices, the unfinished Input/Output size and the corresponding Input/Output time consumption of the storage nodes of the various types corresponding to the path device are collected, then the mapping relationship between the unfinished Input/Output size and the Input/Output time consumption of the storage nodes of the various types is fitted according to the unfinished Input/Output size and the Input/Output time consumption. When the new Input/Output occurs, the target storage node and the candidate path device corresponding to the target storage node are determined, and the estimated time consumption for sending the new Input/Output from the candidate path device to the target storage node is calculated according to the mapping relationship corresponding to the target storage node and the candidate path device. Finally, the estimated time consumption is compared, and the candidate path device corresponding to shortest estimated time consumption is selected as the target path device. By fitting the mapping relationship between the unfinished IO size and IO time consumption of the storage nodes of the various types, it may know the throughput capacity of each path device in different scenarios, which is helpful for manual tuning. At the same time, by dynamically calculating the estimated time consumption for sending IO from the candidate path devices to the target storage node in real time, it effectively saves the time in selecting the path devices. Moreover, the candidate path device corresponding to the shortest estimated time is selected as the target path device, thus greatly improving IO efficiency and reducing IO latency.

### BRIEF DESCRIPTION OF THE DRAWINGS

In order to more clearly illustrate the technical solutions of some embodiments of the present application, the figures that are required to describe the prior art and the embodiments will be briefly described below. Apparently, the figures that are described below are merely some embodiments of the present application, and a person skilled in the art may obtain other figures according to the provided figures without paying creative work.

FIG. 1 is a schematic diagram of networking between a server and a storage system according to some embodiments of the present application;

FIG. 2 is a flow chart of steps of a method for selecting a path device according to some embodiments of the present application;

FIG. 3 is a schematic diagram of a mapping relationship about a master node type according to some embodiments of the present application;

FIG. 4 is a schematic diagram of a mapping relationship about a slave node type according to some embodiments of the present application;

FIG. 5 is a schematic diagram of a mapping relationship about an other-node type according to some embodiments of the present application;

FIG. 6 is a command execution diagram for creating a link according to some embodiments of the present application;

FIG. 7 is a command execution diagram for creating a link according to some embodiments of the present application;

FIG. 8 is a command execution diagram for creating a link according to some embodiments of the present application;

FIG. 9 is a schematic diagram of a circular mirror pair according to some embodiments of the present application;

FIG. 10 is a structural block diagram of an apparatus for selecting a path device according to some embodiments of the present application;

FIG. 11 is a schematic structural diagram of a non-transitory computer-readable storage medium according to some embodiments of the present application; and

FIG. 12 is a schematic diagram of the hardware structure of an electronic device according to some embodiments of the present application.

### DETAILED DESCRIPTION

In order to make the above objectives, features, and advantages of the present application more obvious and understandable, the following will provide further detailed explanations of the present application in conjunction with the accompanying drawings and specific implementation methods.

In order to enable persons skilled in the art to better understand the technical solution of the present application, the following will explain and illustrate some of the technical features involved in some embodiments of the present application:
DM-multipath (Device Mapper Multipath) is a multi-path software solution based on Device Mapper technology on the Linux platform.
Sdx (path device), after the volume is mapped to the server (host), each link will be mapped to a path device.
DM-x (Multi-path Device), DM-multipath aggregates multiple path devices into one multi-path device.
Path selector (path device selection strategy for multi-path software) refers to that when an application program on a server performs IO operations on a multi-path device (DM-x), the multi-path software selects a path device from multiple path devices (Sdx) according to a certain method, and then issues IO. The multi-path software selection strategies for Windows and Linux platforms are roughly the same, with three main selection strategies: round-robin, queue-length, and service-time. Below is a brief introduction to these technologies:

The round robin is to prioritize polling and sending IO on all valid path devices in the optimal path group. If there is no available path device in the optimal path group, polling and sending IO on valid path devices in the non-optimal path group.

The least queue depth is to prioritize sending IO to the path device with the least number of currently unfinished IO requests on the optimal path group.

The service-time is to send IO to the path with the shortest service time.

In order to avoid data access interruption between the server and the storage device caused by the single point of failure, the multi-path software is usually used to solve this problem. Multipath refers to multiple transport layer physical connections between the server and the storage device, providing higher availability and performance advantages for network storage systems. The multipath software is installed on the server side and may aggregate multiple devices of the same volume into one device. The high availability of the multi-path software is reflected in the fact that: if any path between the server and the storage device fails, the IO request may be sent through other paths, avoiding the data access interruptions between the server and the storage device caused by the single point of failure. The high throughput performance advantage of the multi-path software is reflected in the fact that: the IO request from the server to the storage device may be sent concurrently through multiple paths, improving the IO throughput of data access of the server.

Referring to FIG. 1, a schematic diagram of networking between a server and a storage system according to some embodiments of the present application is shown. In FIG. 1, Server is the server, multipath is the multi-path software, HBA is the network card, Switch is the switch, and Controller is the storage controller. In addition, the small cylinder represents the path device, and the large cylinder represents the volume on the storage system. From FIG. 1, it can be seen that the numbers of HBA, Switch, and Controller in the three configurations in the figure are different, and the connection methods are also different. For example, in the configuration diagram on the left side of FIG. 1, there are two Controllers in the storage system, each Controller is connected to one Switch, and each Controller is connected to two volumes, each Switch is connected to one HBA. Therefore, it can be seen that each volume on the storage system corresponds to two devices on the server side. Similarly, both the middle and right configuration diagrams in FIG. 1 may be understood by referring to the left configuration diagram. As the architecture of FIG. 1 is a common multi-path software layout architecture in the prior art, this application will not repeat it.

In some embodiments, during the path selection process, the selection of the optimal path is usually achieved using the multi-path software. Based on the application of the multi-path software, when any path between the server and the storage device fails, an IO request may be sent through other paths to avoid the data access interruption between the server and the storage device caused by the single point of failure. In addition, the IO request from the server to the storage device may be sent concurrently through multiple paths to improve the IO throughput of the server data access. However, the current path selection strategy of multi-path software is not comprehensive enough. In the process of path selection, only the master node where the IO is located is usually selected, without considering the slave nodes and other nodes. In many scenarios, there are already many unfinished IOs on the path of the master node, while the slave nodes and the other nodes are in an idle state, which may easily lead to an increase in path selection time and low IO efficiency. If the slave nodes or the other nodes are selected at this time, it will be more time-saving and efficient.

In this regard, the core of the present application lies in that, relating to storage nodes, the storage nodes have corresponding path devices. For each of the path devices, the unfinished Input/Output size and the corresponding Input/Output time consumption of the storage nodes of the various types corresponding to the path device are collected, then the mapping relationship between the unfinished Input/Output size and the Input/Output time consumption of the storage nodes of the various types is fitted according to the unfinished Input/Output size and the Input/Output time consumption. When the new Input/Output occurs, the target storage node and the candidate path device corresponding to the target storage node are determined, and the estimated time consumption for sending the new Input/Output from the candidate path device to the target storage node is calculated according to the mapping relationship corresponding to the target storage node and the candidate path device. Finally, the estimated time consumption is compared, and the candidate path device corresponding to shortest estimated time consumption is selected as the target path device. In some embodiments of the present application, by fitting the mapping relationship between the unfinished IO size and IO time consumption of the storage nodes of the various types, it may know the throughput capacity of each path device in different scenarios, which is helpful for manual tuning. At the same time, by dynamically calculating the estimated time consumption for sending IO from the candidate path devices to the target storage node in real time, it effectively saves the time in selecting the path devices. Moreover, the candidate path device corresponding to the shortest estimated time is selected as the target path device, thus greatly improving IO efficiency and reducing IO latency.

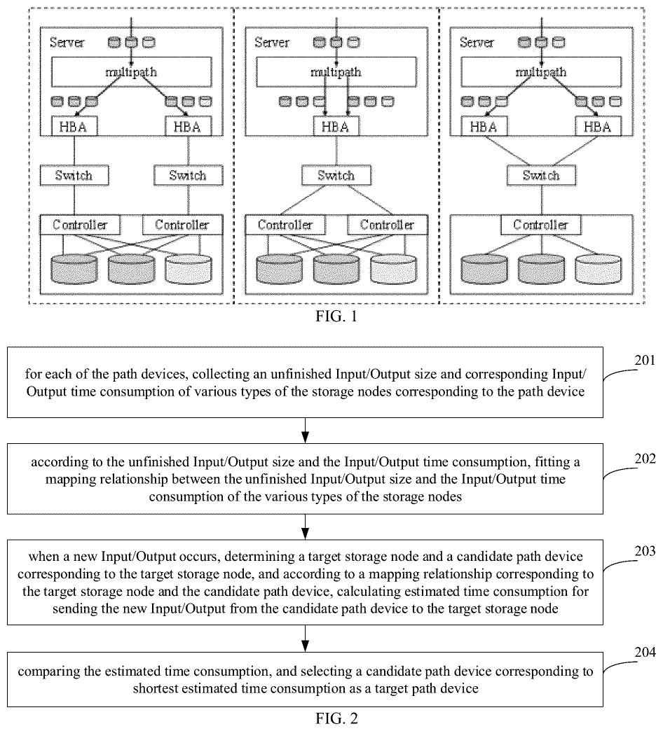

Referring to FIG. 2, a flow chart of steps of a method for selecting a path device according to some embodiments of the present application is shown. The method relates to the storage nodes, the storage nodes have corresponding path devices, and the method may include the following steps:

Step 201, for each of the path devices, collecting an unfinished Input/Output size and corresponding Input/Output time consumption of the storage nodes of various types corresponding to the path device.

The path devices are formed by mapping from the links connecting the server and the storage system, where the quantity of the links corresponds to the quantity of the path devices. For example, if there are 4 links between the server and the storage system, these 4 links may be mapped into 4 path devices, and the path devices are located on the server. For the storage nodes, their types may include a master node type, a slave node type, and an other-node type. The storage nodes are located on the storage system and may correspond to one or more path devices. For example, one storage node may correspond to two path devices.

It should be noted that for the quantity of the storage nodes of the master node type, in the actual IO read and write process, there may be multiple storage nodes of the master node type. Similarly, for the quantity of the storage nodes of the slave node type and the quantity of the storage nodes of the other-node type, in the actual IO read and write process, there may also be multiple storage nodes of the slave node type and multiple storage nodes of the other-node type. Persons skilled in the art may adjust the quantity of the storage nodes of the various types according to the actual situation, and this application does not limit this.

The unfinished IO refers to IO issued from the path device of the server to the storage node, and it belongs to unprocessed IO. Among them, the unfinished IO size refers to the size of the IO that is not processed in the storage node, and the unfinished IO size includes the existing unfinished IO size in the storage node and the IO size when new IO occurs. The IO time consumption refers to the entire process of sending IO from the path device of the server to the storage node, and may be the IO time consumption corresponding to the unfinished IO.

In some embodiments, for each path device, the unfinished IO size and corresponding IO time consumption in the storage nodes of the master node type corresponding to the path device, the unfinished IO size and corresponding IO time consumption in the storage nodes of the slave node type, and the unfinished IO size and corresponding IO time consumption in the storage nodes of the other-node type are collected, to provide basic data support for the subsequent calculation of the estimated time consumption for sending the IO to the target storage node and for the selection of the target path device.

Step 202, according to the unfinished Input/Output size and the Input/Output time consumption, fitting a mapping relationship between the unfinished Input/Output size and the Input/Output time consumption of the storage nodes of the various types.

For the storage nodes, their types may include the master node type, the slave node type, and the other-node type. For the mapping relationship, it may be represented as a straight line between the unfinished IO size and IO time consumption of the storage nodes of the various types, and a linear equation about the straight line may be fitted based on this straight line.

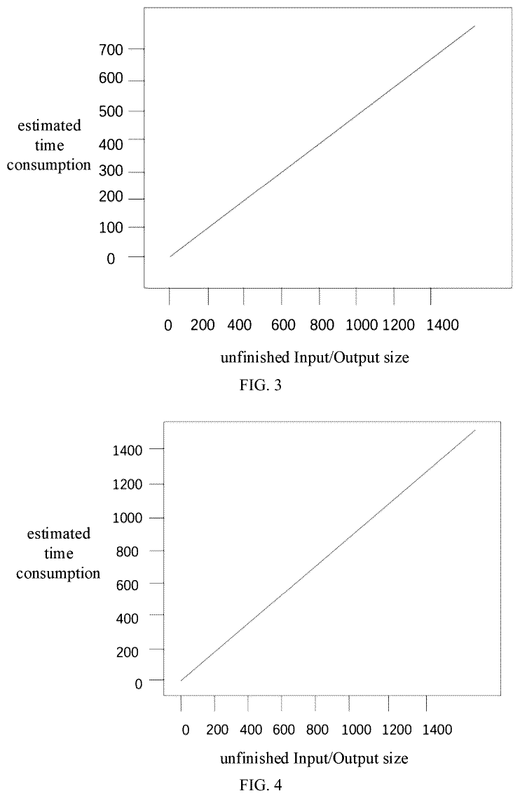

Referring to FIG. 3, a schematic diagram of a mapping relationship about a master node type according to some embodiments of the present application is shown, where the x-axis represents the unfinished IO size in the storage nodes of the master node type, and the y-axis represents the estimated time consumption for sending the IO to the storage nodes of the master node type. Based on the unfinished IO size in the storage nodes of the master node type and the estimated time consumption for sending the IO to the storage nodes of the master node type (as shown in Table 1), a relationship straight line and a linear equation about the storage nodes of the master node type are fitted. In some embodiments, the linear equation is fitted based on the data of the x-axis and y-axis as follows:

$${y}_{1} = 0.49 * {x}_{1} + 0.85$$

Referring to FIG. 4, a schematic diagram of a mapping relationship about a slave node type according to some embodiments of the present application is shown, where the x-axis represents the unfinished IO size in the storage nodes of the slave node type, and the y-axis represents the estimated time consumption for sending the IO to the storage nodes of the slave node type. Based on the unfinished IO size in the storage nodes of the slave node type and the estimated time consumption for sending the IO to the storage nodes of the slave node type (as shown in Table 2), a relationship straight line and a linear equation about the storage nodes of the slave node type are fitted. In some embodiments, the linear equation is fitted based on the data of the x-axis and y-axis as follows:

$${y}_{2} = 1. * {x}_{2} - 4.25$$

Referring to FIG. 5, a schematic diagram of a mapping relationship about an other-node type according to some embodiments of the present application is shown, where the x-axis represents the unfinished IO size in the storage nodes of the other-node type, and the y-axis represents the estimated time consumption for sending the IO to the storage nodes of the other-node type. Based on the unfinished IO size in the storage nodes of the other-node type and the estimated time consumption for sending the IO to the storage nodes of the other-node type (as shown in Table 3), a relationship straight line and a linear equation about the storage nodes of the other-node type are fitted. In some embodiments, the linear equation is fitted based on the data of the x-axis and y-axis as follows:

$${y}_{3} = 1.49 * {x}_{3} - 4.94$$

In some embodiments, by fitting the mapping relationship between the unfinished IO size and corresponding IO time consumption of the storage nodes of the master node type, the mapping relationship between the unfinished IO size and corresponding IO time consumption of the storage nodes of the slave node type, and the mapping relationship between the unfinished IO size and corresponding IO time consumption of the storage nodes of the other-node type according to the unfinished IO size and corresponding IO time consumption of the storage nodes of the master node type, the unfinished IO size and corresponding IO time consumption of the storage nodes of the slave node type, and the unfinished IO size and corresponding IO time consumption of the storage nodes of the other-node type, it may know the throughput capacity of each path device in different scenarios, which is helpful for manual tuning.

Step 203, when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node.

For the target storage node, it may include a master node, a slave node, and other nodes. For the candidate path devices corresponding to the target storage node, they may be multiple path devices. For the mapping relationship, it is the mapping relationship between the target storage node and the candidate path devices corresponding to the target storage node. A straight line is fitted from the unfinished IO size and corresponding IO time consumption of the target storage node, and a linear equation about the straight line is fitted based on the straight line.

Among them, the estimated time consumption is estimated time consumption for sending the IO from the candidate path device to the target storage node, which may be calculated from the mapping relationship between the target storage node and the candidate path device.

In some embodiments, when the new IO occurs, the target storage node and the candidate path device corresponding to the target storage node are determined. Based on the mapping relationship between the target storage node and the candidate path device, the estimated time consumption for sending the new IO from the candidate path device to the target storage node is calculated. By dynamically calculating the estimated time consumption for sending the IO from the candidate path device to the target storage node in real time, the time for selecting the path devices is effectively saved.

Step 204, comparing the estimated time consumption, and selecting a candidate path device corresponding to shortest estimated time consumption as a target path device.

Among them, the target path device is the candidate path device corresponding to the shortest estimated time consumption.

In some embodiments, when the new IO occurs, the target storage node and the candidate path device corresponding to the target storage node are determined. Based on the mapping relationship between the target storage node and the candidate path device, the estimated time consumption for sending the new IO from the candidate path device to the target storage node is calculated. Thus, the estimated time consumption for sending the IO to various types of nodes may be compared, and the candidate path device corresponding to the shortest estimated time consumption may be selected as the target path device. By dynamically calculating the estimated time consumption for sending the IO from the candidate path device to the target storage node in real time, the time for selecting the path devices is effectively saved. Moreover, the candidate path device corresponding to the shortest estimated time is selected as the target path device, thus greatly improving IO efficiency and reducing IO latency.

In some embodiments, the method for selecting a path device relates to storage nodes, the storage nodes have corresponding path devices. For each of the path devices, the unfinished Input/Output size and the corresponding Input/Output time consumption of the storage nodes of the various types corresponding to the path device are collected, then the mapping relationship between the unfinished Input/Output size and the Input/Output time consumption of the storage nodes of the various types is fitted according to the unfinished Input/Output size and the Input/Output time consumption. When the new Input/Output occurs, the target storage node and the candidate path device corresponding to the target storage node are determined, and the estimated time consumption for sending the new Input/Output from the candidate path device to the target storage node is calculated according to the mapping relationship corresponding to the target storage node and the candidate path device. Finally, the estimated time consumption is compared, and the candidate path device corresponding to shortest estimated time consumption is selected as the target path device. By fitting the mapping relationship between the unfinished IO size and IO time consumption of the storage nodes of the various types, it may know the throughput capacity of each path device in different scenarios, which is helpful for manual tuning. At the same time, by dynamically calculating the estimated time consumption for sending IO from the candidate path devices to the target storage node in real time, it effectively saves the time in selecting the path devices. Moreover, the candidate path device corresponding to the shortest estimated time is selected as the target path device, thus greatly improving IO efficiency and reducing IO latency.

In some embodiments, the storage nodes are located on the storage system. Before step 201, for each of the path devices, collecting the unfinished Input/Output size and the corresponding Input/Output time consumption of the storage nodes of the various types corresponding to the path device, the method further includes:

in response to a creation instruction for a server and a volume of the storage node, mapping the volume to the server, wherein the volume is a temporary directory in a lifecycle of the storage node; and

in response to a link creation instruction of the server and the storage system, connecting the server and the storage system through a link, wherein the link is a path from the server to the storage node of the storage system corresponding to the volume.

The volume, located on the storage system, is the temporary directory in the lifecycle of a storage node. When the volume is mapped to the server, the link between the server and the storage system is mapped to a corresponding path device, among them, the path device is located on the server. The link is the path from the server to the storage node of the storage system corresponding to the volume.

In some embodiments, first log into the storage system and create the server and the volume through commands or visual interfaces. It should be noted that the server created here is a concept on the storage system and corresponds to the real server one by one. In this case, if creating an ISCSI (Internet Small Computer System Interface, also known as IP-SAN) link, it needs to fill in IQN (ISCSI (Internet Small Computer System Interface) Qualified Name) information of the server when creating the server. For creating FC (Fiber Channel) links, it needs to fill in WWPN (World Wide Port Name) information of the server. For creating the type of the links, persons skilled in the art may configure it according to actual needs, and the present application does not limit this.

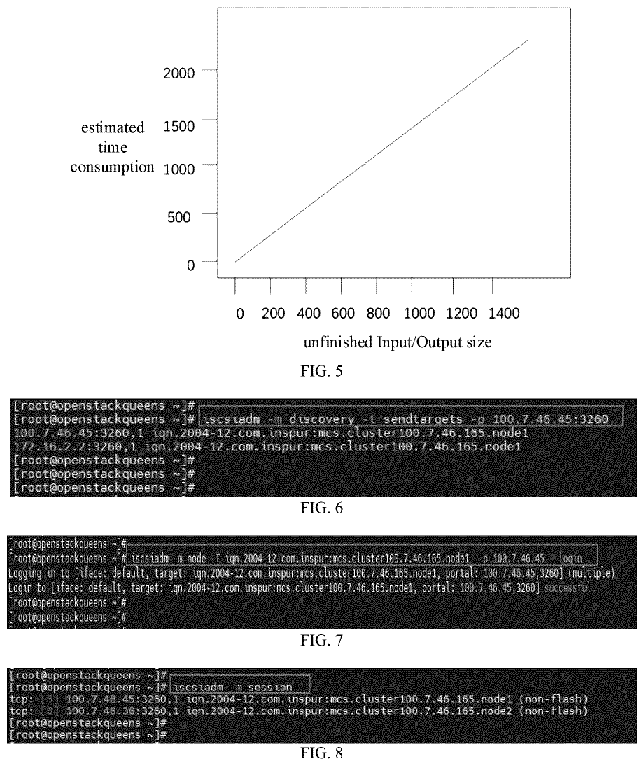

Referring to FIG. 6 to FIG. 8, a command execution diagram for creating a link according to some embodiments of the present application is shown. Assuming that the type of the links is set to ISCSI protocol, the steps for creating a link connecting the server and the storage system are as follows: logging into the server, establishing a link with the storage system through an iscsadm command (usually multiple links exist), and in some embodiments, discovering the target on the storage system through the command: iscsiadm -m discovery -t sendtargets -p ${target_ip}:${port}; next, logging into the target through the command: iscsiadm -m node -T ${target_ign}-p ${target_ip}--login; finally, viewing the established link through the command: iscsiadm -m session. By following the above steps, the link between the server and the storage system may be established.

In some embodiments, after creating the links between the server and the volume, as well as between the server and the storage system, the path devices and the aggregated multi-path devices may be obtained. In some embodiments, logging into the server and scanning through the command: echo ‘- - -’>/sys/class/scsi_host/${hostName}/device/scsi_host/${hostName}/scan, and the path devices may be discovered in the directory (/dev/disk/by-path/). Assuming there are 4 links, each volume corresponds to 4 path devices, such as: /dev/sdb, /dev/sdcm, /dev/sdd, and /dev/sde. In addition, logging into the server, then the multi-path software may be started through the command: systemctl start multipathd, multipathd automatically aggregates devices with the same wwid into one multi-path device, such as: /dev/dm-0. For example, assuming that there are four storage nodes in one IO group, namely storage node 1, storage node 2, storage node 3, and storage node 4, each storage node corresponds to two path devices. To facilitate differentiation, the four storage nodes are represented as Node1, Node2, Node3, and Node4, where multiple IOs form a group and may be issued as one IO group. The relationship among the path devices, the multi-path devices, and the storage nodes is shown in Table 1:

TABLE 1

| multi-path device | Node name | path device |
|---|---|---|
| /dev/dm-0 | Node1 | sdb |
| | | sdc |
| | Node2 | sdd |
| | | sde |
| | Node3 | sdf |
| | | sdg |
| | Node4 | sdh |
| | | sdi |

In some embodiments, in response to the creation instruction or the server and e volume in the storage node, the volume is mapped to the server, among them, the volume is the temporary directory in the lifecycle of the storage node. In addition, in response to the link creation instruction between the server and the storage system, the server is connected to the storage system through the link, among them, the link is the path from the server to the storage node of the storage system corresponding to the volume. When the volume is mapped to the server, the link corresponding to the volume in the storage node is mapped to a path device. Among them, the quantity of the links is the same as the quantity of the path devices corresponding to the volume in the storage node, which means that the storage node corresponds to multiple path devices located on the server. Among them, the multiple path devices are aggregated into one multi-path device.

In some embodiments, step 203, determining the target storage node and the candidate path device corresponding to the target storage node includes:
according to a starting position of the new Input/Output, determining a segment corresponding to the new Input/Output;
according to the segment corresponding to the new Input/Output, determining a mirroring relationship corresponding to the segment; and
determining the target storage node through the mirroring relationship corresponding to the segment, to determine the candidate path device corresponding to the target storage node.

Among them, the starting position is the starting position of the IO on the server. In some embodiments, the IO is issued from the server to the storage system.

For the segments, the volume is divided into multiple segments according to the preset segment granularity, and each segment corresponds to multiple starting positions. For example, assuming that each volume on the storage node is divided into 4 segments at a segment granularity, with a partition value set to 32M, in order to facilitate differentiation, the segments are represented by L, and the 4 L (segments) are: L1:{[0,32M),[128M,160M), . . . }; L2:{[32M,64M),[160M,192M), . . . }; L3:{[64M,96M),[192M,224M), . . . }; L4: {[96M,128M),[224M,256M), . . . }.

For the mirroring relationship, multiple storage nodes within an IO group are divided into multiple mirroring relationships, among them, multiple IOs form an IO group, and the quantity of the mirroring relationships is the same as the quantity of the storage nodes in the IO group and the quantity of the segments. For example, assuming that there are four storage nodes in one IO group, namely the storage node 1, the storage node 2, the storage node 3, and the storage node 4, in order to facilitate differentiation, the four storage nodes are represented as Node1, Node2, Node3, and Node4. The four mirroring relationships are represented as: Domain1:(Node1,Node2); Domain2:(Node2,Node3); Domain3:(Node3,Node4); Domain4:(Node4,Node1).

It should be noted that for ease of description, the storage node may be represented as Node, the mirroring relationship may be represented as Domain, and the segment may be represented as L. It can be understood that persons skilled in the art may adjust the expression methods of the storage nodes, the mirroring relationships, and the segments according to actual situations, and the embodiments of the present application do not limit this.

Among them, there is a relationship between the segments and various types of the storage nodes, as shown in Table 2:

TABLE 2

| Segment | Master node | Slave node | Other nodes |
|---|---|---|---|
| L1 | Node1 | Node2 | Node3/Node4 |
| L2 | Node2 | Node3 | Node1/Node4 |
| L3 | Node3 | Node4 | Node1/Node2 |
| L4 | Node4 | Node1 | Node2/Node3 |

As shown in the figure, the master node corresponding to L1 is Node1, the slave node corresponding to L1 is Node2, and the other nodes corresponding to L1 are Node3 and Node4. Similarly, the master node corresponding to L2 is Node2, the slave node corresponding to L2 is Node3, and the other nodes corresponding to L2 are Node1 and Node4. While the master node corresponding to L3 is Node3, the slave node corresponding to L3 is Node4, and the other nodes corresponding to L3 are Node1 and Node2. The master node corresponding to L4 is Node4, the slave node corresponding to L4 is Node1, and the other nodes corresponding to L4 are Node2 and Node3.

It should be noted that the above embodiments are only used as examples. In the actual IO read and write process, for the quantity of the storage nodes of the master node type, there may be multiple storage nodes of the master node type. Similarly, for the quantity of the storage nodes of the slave node type and the quantity of the storage nodes of the other-node type, there may also be multiple storage nodes of the slave node type and multiple storage nodes of the other-node type in the actual IO read and write process. For example, the quantity of the storage nodes of the master node type corresponding to L1 may be much more than 1, the quantity of the storage nodes of the slave node type may be much more than 1, and the quantity of the storage nodes of the other-node type may be much more than 2. Similarly, there may be more than two storage nodes of the various storage node types corresponding to L2, L3, and L4. Here, the data is set relatively simply for the convenience of illustration, and it can be understood that the present application does not limit it.

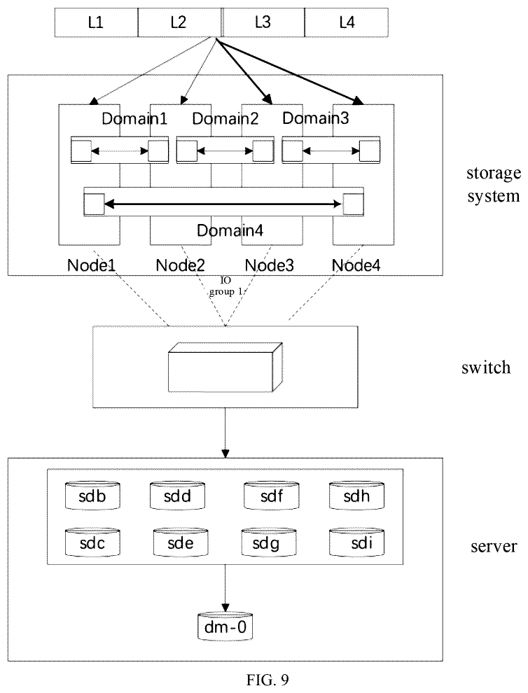

Referring to FIG. 9, a schematic diagram of a circular mirror pair according to some embodiments of the present application is shown. As can be seen from the figure, the storage nodes, the segments, and the corresponding mirroring relationships are located on the storage system, connected to the server through the switch, and the storage system and the server are connected through the links. There are multiple path devices on the server, such as: sdb, sdc, sdd, sde, sdf, sdg, sdh, and sdi, which are then aggregated into one multi-path device, such as dm-0.

In one example, assuming that the starting position of the IO is 25M and the size is 512 KB, according to the division of the segments and the mirroring relationships mentioned above, this IO belongs to L1, and the corresponding mirroring relationship for L1 is Domain1, among them, the master node of Domain1 is node1, and the path devices connecting the node1 to the server are sdb and sdc.

From the above chart, it can be seen that when the IO belongs to L1, assuming the path to send the IO to Node1, the unfinished IO size and final time consumption become sample data on the master node. Assuming the path to send the IO to Node2, the unfinished IO size and final time consumption become sample data on the slave node. Assuming the path to send the IO to Node3 or Node4, the unfinished IO size and final time consumption become sample data on the other nodes. It should be noted that the unfinished IO size includes the existing unfinished IO size on this path and the IO size that occurred this time.

Similarly, when the IO belongs to L2, assuming the path to send the IO to Node2, the unfinished IO size and final time consumption become sample data on the master node. Assuming the path to send the IO to Node2, the unfinished IO size and final time consumption become sample data on the slave node. Assuming the path to send the IO to Node1 or Node4, the unfinished IO size and final time consumption become sample data on the other nodes.

When the IO belongs to L3, assuming the path to send the IO to Node3, the unfinished IO size and final time consumption become sample data on the master node. Assuming the path to send the IO to Node4, the unfinished IO size and final time consumption become sample data on the slave node. Assuming the path to send the IO to Node1 or Node2, the unfinished IO size and final time consumption become sample data on the other nodes.

When the IO belongs to L4, assuming the path to send the IO to Node4, the unfinished IO size and final time consumption become sample data on the master node. Assuming the path to send the IO to Node1, the unfinished IO size and final time consumption become sample data on the slave node. Assuming the path to send the IO to Node2 or Node3, the unfinished IO size and final time consumption become sample data on the other nodes.

The following is a sample data table of the unfinished IO size and corresponding IO time consumption collected from the storage nodes of the various types:
the unfinished IO size and corresponding IO time consumption in the master node are shown in Table 3:

TABLE 3

| the unfinished IO size (KB) | time consumption (millisecond) |
|---|---|
| 32 | 19 |
| 64 | 31 |
| 128 | 64 |
| 248 | 127 |
| 256 | 119 |
| 512 | 264 |
| 768 | 392 |
| 1024 | 509 |
| 1056 | 524 |

The unfinished IO size and corresponding IO time consumption in the other nodes are shown in Table 4:

TABLE 4

| the unfinished IO size (KB) | time consumption (millisecond) |
|---|---|
| 32 | 26 |
| 64 | 61 |
| 128 | 122 |
| 248 | 250 |
| 256 | 247 |
| 512 | 519 |
| 768 | 770 |
| 1024 | 1023 |
| 1056 | 1057 |

The unfinished IO size and corresponding IO time consumption in the other nodes are shown in Table 5:

TABLE 5

| the unfinished IO size (KB) | time consumption (millisecond) |
|---|---|
| 32 | 13 |
| 64 | 32 |
| 128 | 66 |
| 248 | 123 |
| 256 | 130 |
| 512 | 258 |
| 768 | 388 |
| 1024 | 521 |
| 1056 | 534 |

In some embodiments, based on the starting position of the new IO, the segment corresponding to the new IO is determined. Then, based on the segment corresponding to the new IO, the mirroring relationship corresponding to the segment is determined. Finally, the target storage node is determined through the mirroring relationship corresponding to the segment, to determine the candidate path devices corresponding to the target storage node. By dividing the volume into multiple segments and dividing multiple nodes in the IO group into corresponding mirroring relationships, the type of the target storage node may be more easily determined, to determine the candidate path devices corresponding to the target storage node, thus improving the selection efficiency of the path devices.

In some embodiments, types of the storage nodes comprise a master node type, and step 202, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the master node type; and
according to the unfinished Input/Output size and the Input/Output time consumption, fitting a mapping relationship between the unfinished Input/Output size and the Input/Output time consumption of the storage node of the master node type.

Among them, for the mapping relationship, it may be represented as a straight line about the unfinished IO size and the IO time consumption of the master node, and a linear equation about the straight line may be fitted based on the straight line, so that the estimated time consumption for sending the IO to the master node may be obtained based on the linear equation.

In some embodiments, the unfinished IO size and corresponding IO time consumption in the storage node of the master node type are collected, and then the mapping relationship between the unfinished IO size and the IO time consumption of the storage node of the master node type is fitted based on the unfinished IO size and the IO time consumption. By using the mapping relationship between the unfinished IO size and the IO time consumption of the storage node of the master node type, the estimated time consumption for sending the IO to the master node may be obtained based on this mapping relationship.

In some embodiments, types of the storage nodes comprise a slave node type, and step 202, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the slave node type; and
according to the unfinished Input/Output size and the Input/Output time consumption, fitting a mapping relationship between the unfinished Input/Output size and the Input/Output time consumption of the storage node of the slave node type.

Among them, for the mapping relationship, it may be represented as a straight line about the unfinished IO size and the IO time consumption of the slave node, and a linear equation about the straight line may be fitted based on the straight line, so that the estimated time consumption for sending the IO to the slave node may be obtained based on the linear equation.

In some embodiments, the unfinished IO size and corresponding IO time consumption in the storage node of the slave node type are collected, and then the mapping relationship between the unfinished IO size and the IO time consumption of the storage node of the slave node type is fitted based on the unfinished IO size and the IO time consumption. By using the mapping relationship between the unfinished IO size and the IO time consumption of the storage node of the slave node type, the estimated time consumption for sending the IO to the slave node may be obtained based on this mapping relationship.

In some embodiments, types of the storage nodes comprise an other-node type, and step 202, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the other-node type; and
according to the unfinished Input/Output size and the Input/Output time consumption, fitting a mapping relationship between the unfinished Input/Output size and the Input/Output time consumption of the storage node of the other-node type.

Among them, for the mapping relationship, it may be represented as a straight line about the unfinished IO size and the IO time consumption of the other nodes, and a linear equation about the straight line may be fitted based on the straight line, so that the estimated time consumption for sending the IO to the other nodes may be obtained based on the linear equation.

In some embodiments, the unfinished IO size and corresponding IO time consumption in the storage node of the other-node type are collected, and then the mapping relationship between the unfinished IO size and the IO time consumption of the storage node of the other-node type is fitted based on the unfinished IO size and the IO time consumption. By using the mapping relationship between the unfinished IO size and the IO time consumption of the storage node of the other-node type, the estimated time consumption for sending the IO to the other nodes may be obtained based on this mapping relationship.

In some embodiments, step 203, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining a master node and a candidate path device corresponding to the master node; and
according to the mapping relationship corresponding to the master node and the candidate path device, calculating estimated time consumption for sending the new Input/Output from the candidate path device to the master node.

In some embodiments, when the new IO occurs, the master node and the candidate path device corresponding to the master node are determined, and the estimated time consumption for sending the new IO from the candidate path device to the master node is calculated according to the mapping relationship corresponding to the master node and the candidate path device.

In some embodiments, step 203, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining a slave node and a candidate path device corresponding to the slave node; and
according to the mapping relationship corresponding to the slave node and the candidate path device, calculating estimated time consumption for sending the new Input/Output from the candidate path device to the slave node.

In some embodiments, when the new IO occurs, the slave node and the candidate path device corresponding to the slave node are determined, and the estimated time consumption for sending the new IO from the candidate path device to the slave node is calculated according to the mapping relationship corresponding to the slave node and the candidate path device.

In some embodiments, step 203, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining other nodes and candidate path devices corresponding to the other nodes; and
according to the mapping relationship corresponding to the other nodes and the candidate path devices, calculating estimated time consumption for sending the new Input/Output from the candidate path devices to the other nodes.

In some embodiments, when the new IO occurs, the other nodes and the candidate path devices corresponding to the other nodes are determined, and the estimated time consumption for sending the new IO from the candidate path devices to the other nodes is calculated according to the mapping relationship corresponding to the other nodes and the candidate path devices.

In some embodiments, step 104, comparing the estimated time consumption, and selecting the candidate path device corresponding to the shortest estimated time consumption as the target path device comprises:
comparing the estimated time consumption for sending the new Input/Output from the candidate path device to the master node, estimated time consumption for sending the new Input/Output from the candidate path device to a slave node, and estimated time consumption for sending the new Input/Output from the candidate path devices to other nodes, to obtain the shortest estimated time consumption; and
selecting the candidate path device corresponding to the shortest estimated time consumption as the target path device.

In some embodiments, when calculating the estimated time consumption for sending the new IO from the candidate path device to the master node, the estimated time consumption for sending the new IO from the candidate path device to the slave node, and the estimated time consumption for sending the new IO from the candidate path devices to the other node, the shortest estimated time consumption may be obtained, therefore, the candidate path device corresponding to the shortest estimated time consumption is selected as the target path device.

It should be noted that there is a local synchronization mechanism set inside the storage system. In some embodiments, as shown in FIG. 9, assuming that the IO data in L1 (segment) on the storage system is stored in the master node Node1 and the slave node Node2, it can be understood that the mirroring relationship corresponding to L1 is Domain1:(Node1,Node2), When the server needs to read the IO data stored in L1 on the storage system, if the storage node corresponding to the path device with the shortest estimated time consumption calculated by the above method is the other node Node3, the server needs to send the read command to the other node Node3. Since the other node Node3 itself does not store the IO data in L1, it cannot be sent to the other node Node3. However, during the entire process, the IO data in L1 may be synchronized from the master node Node1 and/or the slave node Node2 to the other node Node3 through the local synchronization mechanism set inside the storage system, so that the server may send the read instruction to the other node Node3 corresponding to the path device with the shortest estimated time consumption, and execute the command of reading the IO data. Similarly, the data synchronization methods among the storage nodes in L2, L3, and L4 are the same as the example in L1, and will not be repeated in the present application. In addition, as the local synchronization mechanism set inside the storage system is the mean of the prior art, the present application will not repeat it here.

In some embodiments, based on the estimated time consumption for sending the new IO from the candidate path device to the master node, the estimated time consumption for sending the new IO from the candidate path device to the slave node, and the estimated time consumption for sending the new IO from the candidate path devices to the other nodes obtained in the above steps, the estimated time consumption for sending the new IO from the candidate path device to the master node, the estimated time consumption for sending the new IO from the candidate path device to the slave node, and the estimated time consumption for sending the new IO from the candidate path devices to the other nodes are compared to obtain the shortest estimated time consumption. The candidate path device corresponding to the shortest estimated time consumption is selected as the target path device, and the new IO is issued to the target storage node through the target path device. By dynamically calculating the estimated time consumption for sending the IO from the candidate path devices to the target storage node in real time, it effectively saves the time in selecting the path devices. Moreover, the candidate path device corresponding to the shortest estimated time is selected as the target path device, thus greatly improving IO efficiency and reducing IO latency.

In order to enable persons skilled in the art to better understand the technical solutions in some embodiments of the present application, the following examples are used for illustrative explanation.

Since the unfinished IO size includes the existing unfinished IO size in the storage node and the IO size when the new IO occurs, it is assumed that the currently existing unfinished IO sizes on the path of each node are as shown in Table 6:

TABLE 6

| Node name | Path device | currently unfinished IO size |
|---|---|---|
| Node1 | sdb | 512 |
| | sdc | 600 |
| Node2 | sdd | 128 |
| | sde | 64 |
| Node3 | sdf | 256 |
| | sdg | 200 |
| Node4 | sdh | 250 |
| | sdi | 286 |

Assuming that a new IO occurs, a starting position of the new IO is 16M and a size of the new IO is 64 KB, the new IO belongs to segment L1, and the segment L1 corresponds to the mirroring relationship Domain1. The master node corresponding to Domain1 is Node1, and the path devices corresponding to Node1 are sdb and sdc. The slave node is Node2, and the path devices corresponding to Node2 are sdd and sde. The other nodes are Node3 and Node4, the path devices corresponding to Node3 are sdf and sdg, and the path devices corresponding to Node4 are sdh and sdi. Based on the mapping relationship corresponding to each storage node and the candidate path devices, in some embodiments, the estimated time consumption for sending the new IO from the candidate path devices to the master node, the estimated time consumption for sending the new IO from the candidate path devices to the slave node, and the estimated time consumption for sending the new IO from the candidate path device to the other nodes are calculated according to the corresponding linear equations, and the shortest estimated time consumption is obtained. The calculation steps are as follows (all relevant data are explained using the figures and tables that appear above).

The estimated time consumption for sending the new IO from the candidate path devices to the master node:

The path device is sdb, and the estimated time consumption is 0.49*(512+64)+0.85=283.09.

The path device is sdc, and the estimated time consumption is 0.49*(600+64)+0.85=326.21.

The estimated time consumption for sending the new IO from the candidate path devices to the slave node:

The path device is sdd, and the estimated time consumption is 1.00*(128+64)−4.25=187.75.

The path device is sde, and the estimated time consumption is 1.00*(64+64)−4.25=123.75.

The estimated time consumption for sending the new IO from the candidate path devices to the other nodes:

The path device is sdf, and the estimated time consumption is 1.49*(256+64)−4.94=471.86.

The path device is sdg, and the estimated time consumption is 1.49*(200+64)−4.94=388.42.

The path device is sdh, and the estimated time consumption is 1.49*(250+64)−4.94=462.92.

The path device is sdi, and the estimated time consumption is 1.49*(286+64)−4.94=516.56.

It can be seen that if the IO is sent to the path device sde, the estimated time consumption is the shortest. Therefore, the path device sde is taken as the target path device, and the IO is sent to the target path device sde, so as to issue a new IO to the target storage node through the target path device sde.

In summary, real-time prediction and selection of the target path devices are achieve.

It should be noted that for the sake of simplicity, the method embodiments are described as a series of action combinations. However, persons skilled in the art should be aware that the embodiments of the present application are not limited by the order of the described actions, because according to the embodiments of the present application, certain steps may be performed in other orders or simultaneously. Secondly, persons skilled in the art should also be aware that the embodiments described in the specification are all preferred embodiments, and the actions involved are not necessarily necessary for the embodiments of the present application.

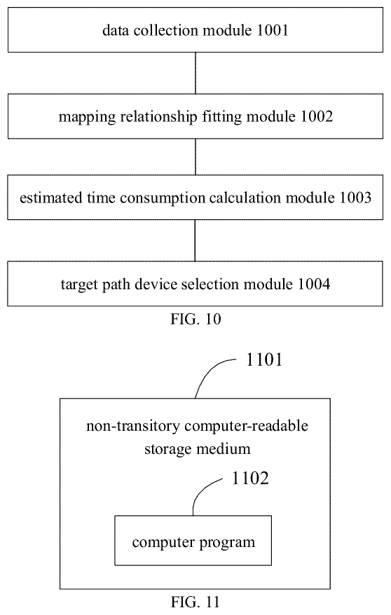

Referring to FIG. 10, a structural block diagram of an apparatus for selecting a path device according to some embodiments of the present application is shown, and the apparatus may include the following modules:
a data collection module 1001 configured for, for each of the path devices, collecting an unfinished Input/Output size and corresponding Input/Output time consumption of the storage nodes of various types corresponding to the path device;
a mapping relationship fitting module 1002 configured for, according to the unfinished Input/Output size and the Input/Output time consumption, fitting a mapping relationship between the unfinished Input/Output size and the Input/Output time consumption of the storage nodes of the various types;
an estimated time consumption calculation module 1003 configured for, when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; and
a target path device selection module 1004 configured for comparing the estimated time consumption, and selecting a candidate path device corresponding to shortest estimated time consumption as a target path device.

In some embodiments, types of the storage nodes comprise a master node type, and the mapping relationship fitting module 1002 is configured for:
collecting an unfinished Input/Output size and corresponding Input/Output time consumption of a storage node of the master node type; and
according to the unfinished Input/Output size and the Input/Output time consumption, fitting a mapping relationship between the unfinished Input/Output size and the Input/Output time consumption of the storage node of the master node type.

In some embodiments, types of the storage nodes comprise a slave node type, and the mapping relationship fitting module 1002 is configured for:
collecting an unfinished Input/Output size and corresponding Input/Output time consumption of a storage node of the slave node type; and
according to the unfinished Input/Output size and the Input/Output time consumption, fitting a mapping relationship between the unfinished Input/Output size and the Input/Output time consumption of the storage node of the slave node type.

In some embodiments, types of the storage nodes comprise an other-node type, and the mapping relationship fitting module 1002 is configured for:
collecting an unfinished Input/Output size and corresponding Input/Output time consumption of a storage node of the other-node type; and
according to the unfinished Input/Output size and the Input/Output time consumption, fitting a mapping relationship between the unfinished Input/Output size and the Input/Output time consumption of the storage node of the other-node type.

In some embodiments, the estimated time consumption calculation module 1003 is configured for:
when the new Input/Output occurs, determining a master node and a candidate path device corresponding to the master node; and
according to the mapping relationship corresponding to the master node and the candidate path device, calculating estimated time consumption for sending the new Input/Output from the candidate path device to the master node.

In some embodiments, the estimated time consumption calculation module 1003 is configured for:
when the new Input/Output occurs, determining a slave node and a candidate path device corresponding to the slave node; and
according to the mapping relationship corresponding to the slave node and the candidate path device, calculating estimated time consumption for sending the new Input/Output from the candidate path device to the slave node.

In some embodiments, the estimated time consumption calculation module 1003 is configured for:
when the new Input/Output occurs, determining other nodes and candidate path devices corresponding to the other nodes; and
according to the mapping relationship corresponding to the other nodes and the candidate path devices, calculating estimated time consumption for sending the new Input/Output from the candidate path devices to the other nodes.

In some embodiments, the target path device selection module 1004 is configured for:
comparing the estimated time consumption for sending the new Input/Output from the candidate path device to the master node, estimated time consumption for sending the new Input/Output from the candidate path device to a slave node, and estimated time consumption for sending the new Input/Output from the candidate path devices to other nodes, to obtain the shortest estimated time consumption; and
selecting the candidate path device corresponding to the shortest estimated time consumption as the target path device.

For the device implementation example, due to its basic similarity with the method implementation example, the description is relatively simple. For relevant information, please refer to the partial explanation of the method implementation example.

In addition, the present application also provides an electronic device in some embodiments, comprising a processor, a memory, and a computer program stored on the memory and executable on the processor. When the computer program is executed by the processor, it implements the various processes of the method for selecting the path device described above and may achieve the same technical effect. To avoid repetition, it will not be repeated here.

FIG. 11 is a schematic structural diagram of a non-transitory computer-readable storage medium according to some embodiments of the present application.

In some embodiments, the present application also provides a non-transitory computer-readable storage medium 1101, which stores a computer program 1102. When the computer program 1102 is executed by a processor, it implements the various processes of the method for selecting the path device described above and may achieve the same technical effect. To avoid repetition, it will not be repeated here. Among them, the non-transitory computer-readable storage media 1101 may be Read-Only Memory (ROM), Random Access Memory (RAM), magnetic disks or optical disks, etc.

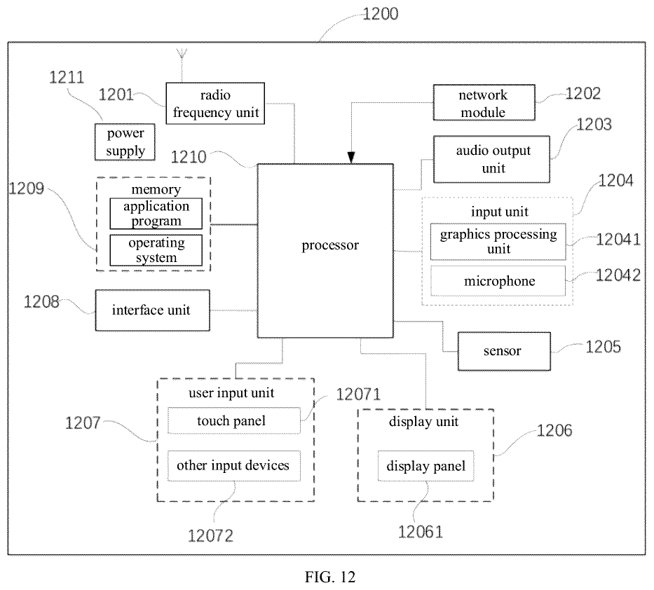

FIG. 12 is a schematic diagram of the hardware structure of an electronic device according to some embodiments of the present application.

The electronic device 1200 includes but is not limited to: a radio frequency unit 1201, a network module 1202, an audio output unit 1203, an input unit 1204, a sensor 1205, a display unit 1206, a user input unit 1207, an interface unit 1208, a memory 1209, a processor 1210, and a power supply 1211. Persons skilled in the art may understand that the structure of the electronic device shown in FIG. 12 does not constitute a limitation on the electronic device. The electronic device may include more or fewer components than shown in the diagram, or combine certain components, or arrange different components. In some embodiments, the electronic devices include but are not limited to mobile phones, tablets, laptops, handheld computers, vehicle terminals, wearable devices, and pedometers.

It should be understood that in some embodiments, the radio frequency unit 1201 may be used for receiving and transmitting signals during the process of transmitting and receiving information or communication. After receiving downlink data from the base station, it is processed by the processor 1210. In addition, it may send the uplink data to the base station. Generally, the radio frequency unit 1201 includes but is not limited to an antenna, at least one amplifier, a transceiver, a coupler, a low-noise amplifier, a duplexer, etc. In addition, the radio frequency unit 1201 may also communicate with networks and other devices through wireless communication systems.

The electronic devices provide users with wireless broadband Internet access through the network module 1202, such as helping the users send and receive emails, browse web pages, and access streaming media.

The audio output unit 1203 may convert audio data received by the radio frequency unit 1201 or the network module 1202, or stored in the memory 1209, into audio signals and output them as sound. Moreover, the audio output unit 1203 may also provide audio outputs related to specific functions performed by the electronic device 1200 (such as call signal reception sound, message reception sound, etc.). The audio output unit 1203 includes a speaker, buzzer, and receiver, etc.

The input unit 1204 is used to receive audio or video signals. The input unit 1204 may include a Graphics Processing Unit (GPU) 12041 and a microphone 12042. The GPU 12041 processes image data of static images or videos obtained by an image capture device (such as a camera) in a video capture mode or an image capture mode. The processed image frames may be displayed on the display unit 1206. The image frames processed by the GPU 12041 may be stored in the memory 1209 (or other storage media) or sent via the radio frequency unit 1201 or the network module 1202. The microphone 12042 may receive sound and processing it into audio data. The processed audio data may be converted into a format output that may be sent to a mobile communication base station via the radio frequency unit 1201 in telephone call mode.

The electronic device 1200 also includes at least one sensor 1205, such as a light sensor, a motion sensor, and other sensors. In some embodiments, the light sensor includes an ambient light sensor and a proximity sensor, among them, the ambient light sensor may adjust the brightness of the display panel 12061 according to the brightness of the ambient light, and the proximity sensor may turn off the display panel 12061 and/or backlight when the electronic device 1200 is moved to the ear. As a type of the motion sensor, accelerometer sensors may detect the magnitude of acceleration in various directions (usually three axes), and may detect the magnitude and direction of gravity when stationary. They may be used to recognize postures of the electronic device (such as horizontal and vertical screen switching, related games, magnetometer posture calibration), vibration recognition related functions (such as pedometers, strikes), etc. The sensor 1205 may also include fingerprint sensors, pressure sensors, iris sensors, molecular sensors, gyroscopes, barometers, hygrometers, thermometers, infrared sensors, etc., which will not be repeated here.

The display unit 1206 is used to display information input by the user or information provided to the user. The display unit 1206 may include a display panel 12061, which may be configured in the form of a liquid crystal display (LCD), an organic light-emitting diode (OLED), and so on.

The user input unit 1207 may be used to receive input numerical or character information, as well as generate key signal inputs related to user settings and functional controls of the electronic devices. In some embodiments, the user input unit 1207 includes a touch panel 12071 and other input devices 12072. The touch panel 12071, also known as a touch screen, may collect touch operations of the user on or near it (such as operations of the user using fingers, stylus, or any suitable object or accessory on or near the touch panel 12071). The touch panel 12071 may include two parts: a touch detection device and a touch controller. Among them, the touch detection device detects the touch direction of the user and detects the signal brought by the touch operation, and transmits the signal to the touch controller. The touch controller receives touch information from the touch detection device, converts it into touch point coordinates, and sends them to the processor 1210. It receives commands from the processor 1210 and executes them. In addition, the touch panel 12071 may be implemented using various types such as resistive, capacitive, infrared, and surface acoustic waves. In addition to the touch panel 12071, the user input unit 1207 may also include other input devices 12072. In some embodiments, other input devices 12072 may include but are not limited to physical keyboards, function keys (such as volume control buttons, switch buttons, etc.), trackballs, mouse, and joysticks, which will not be repeated here.

Furthermore, the touch panel 12071 may cover the display panel 12061. When the touch panel 12071 detects a touch operation on or near it, it is transmitted to the processor 1210 to determine the type of a touch event. Subsequently, the processor 1210 provides corresponding visual output on the display panel 12061 based on the type of the touch event. Although in FIG. 12, the touch panel 12071 and the display panel 12061 are used as two independent components to implement the input and output functions of the electronic device, in some embodiments, the touch panel 12071 and the display panel 12061 may be integrated to achieve the input and output functions of the electronic device, and the specific details are not limited here.

The interface unit 1208 is the interface for connecting external devices to the electronic device 1200. For example, the external devices may include wired or wireless headphone ports, external power supply (or battery charger) ports, wired or wireless data ports, memory card ports, ports for connecting devices with identification modules, audio input/output (I/O) ports, video I/O ports, headphone ports, and so on. The interface unit 1208 may be used to receive inputs from the external devices (such as data information, power, etc.) and transmit the received inputs to one or more components within the electronic device 1200, or may be used to transmit data between the electronic device 1200 and the external devices.

The memory 1209 may be used to store software programs and various data. The memory 1209 may mainly include a storage program area and a storage data area, among them, the storage program area may store an operating system, at least one application program required for a function (such as a sound playback function, an image playback function, etc.), etc. The storage data area may store data (such as audio data, phone books, etc.) created based on the usage of the mobile phone. In addition, the memory 1209 may include high-speed random access memory, as well as non-transitory memory such as at least one disk storage device, flash memory device, or other transitory solid-state storage device.

The processor 1210 is the control center of the electronic devices, which connects various parts of the entire electronic device through various interfaces and circuits. By running or executing software programs and/or modules stored in the memory 1209, as well as calling data stored in the memory 1209, it performs various functions of the electronic device and processes data, thereby monitoring the electronic device as a whole. The processor 1210 may include one or more processing units. In some embodiments, the processor 1210 may integrate an application processor and a modem processor, among them, the application processor primarily handles operating systems, user interfaces, and application programs, and the modem processor primarily handles wireless communication. It can be understood that the above modem processor may not be integrated into the processor 1210.

The electronic device 1200 may also include a power supply 1211 (such as a battery) that supplies power to various components. In some embodiments, the power supply 1211 may be logically connected to the processor 1210 through a power management system, thereby achieving functions such as managing charging, discharging, and power consumption through the power management system.

In addition, the electronic device 1200 includes some functional modules that are not shown and will not be further elaborated here.

It should be noted that in this specification, the terms “comprising”, “including”, or any other variation thereof are intended to encompass non-exclusive inclusion, such that a process, method, article, or apparatus that includes a series of elements not only includes those elements, but also includes other elements not explicitly listed, or also includes elements inherent to such process, method, article, or apparatus. Without further limitations, the element limited by the statement “including one . . . ” does not exclude the existence of other identical elements in the process, method, article, or device that includes that element.

Through the description of the above implementation methods, persons skilled in the art may clearly understand that the above implementation methods may be implemented through software and necessary general hardware platforms. Certainly, they may also be implemented through hardware, but in many cases, the former is the better implementation method. Based on this understanding, the technical solution of the present application may essentially or contribute to the existing technology in the form of a software product, which is stored in a storage medium (such as ROM/RAM, magnetic disk, optical disk) and includes several instructions to enable a terminal (which may be a mobile phone, computer, server, air conditioner, or network device, etc.) to execute the methods of various embodiments of the present application.

The embodiments of the present application have been described above in conjunction with the accompanying drawings, but the present application is not limited to the specific embodiments described above. The specific embodiments described above are only illustrative and not restrictive. Persons skilled in the art may also make many forms within the scope of protection of the present application without departing from the purpose and claims of the present application.

Persons skilled in the art may realize that the units and algorithm steps described in the embodiments disclosed in the present application may be implemented through electronic hardware, or a combination of computer software and electronic hardware. Whether these functions are executed in hardware or software depends on the specific application and design constraints of the technical solution. Professional technicians may use different methods to achieve the described functions for each specific application, but such implementation should not be considered beyond the scope of the present application.

Persons skilled in the art may clearly understand that, for the sake of convenience and simplicity in description, the specific working processes of the systems, devices, and units described above may refer to the corresponding processes in the aforementioned method embodiments, which will not be repeated here.

In the embodiments provided in the present application, it should be understood that the disclosed devices and methods may be implemented in other ways. For example, the device embodiments described above are only illustrative. For example, the division of units is only a logical function division. In practical implementation, there may be other division methods, such as multiple units or components being combined or integrated into another system, or some features being ignored or not executed. On the other hand, the mutual coupling or direct coupling or communication connection displayed or discussed may be indirect coupling or communication connection through some interface, device or unit, which may be electrical, mechanical or other forms.

The units described as separate components may or may not be physically separated, and the components displayed as units may or may not be physical units, i.e., they may be located in one place or distributed across multiple network units. Some or all of the units may be selected according to actual needs to achieve the purpose of this embodiment.

In addition, the functional units in various embodiments of the present application may be integrated into one processing unit, physically exist separately, or integrate two or more units into one unit.

If the function is implemented in the form of software functional units and sold or used as an independent product, it may be stored in a computer-readable storage medium. Based on this understanding, the technical solution of the present application essentially or partially contributes to the prior art or may be embodied in the form of a software product. The computer software product is stored in a storage medium and includes several instructions to enable a computer device (which may be a personal computer, server, or network device, etc.) to perform all or part of the steps of the various embodiments of the present application. The aforementioned storage media include various media that may store program code, such as USB flash drives, portable hard drives, ROMs, RAMs, disks, or CDs.

The above is only a specific implementation of the present application, but the scope of protection of the present application is not limited to this. Any skilled person familiar with the technical field may easily think of changes or replacements within the technical scope disclosed in the present application, which should be included in the scope of protection of the present application. Therefore, the scope of protection of this application should be based on the scope of protection of the claims.

1. A method for selecting a path device, relating to storage nodes, wherein the storage nodes have corresponding path devices, and the method comprises:
for each of the path devices, collecting an unfinished Input/Output size and corresponding Input/Output time consumption of the storage nodes of various types corresponding to the path device;
according to the unfinished Input/Output size and the Input/Output time consumption, fitting a mapping relationship between the unfinished Input/Output size and the Input/Output time consumption of the storage nodes of the various types;
when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; and
comparing the estimated time consumption, and selecting a candidate path device corresponding to shortest estimated time consumption as a target path device.

2. The method according to claim 1, wherein the storage nodes are located on a storage system, and before the step of, for each of the path devices, collecting the unfinished Input/Output size and the corresponding Input/Output time consumption of the storage nodes of the various types corresponding to the path device, the method further comprises:
in response to a creation instruction for a server and a volume of the storage node, mapping the volume to the server, wherein the volume is a temporary directory in a lifecycle of the storage node; and
in response to a link creation instruction of the server and the storage system, connecting the server and the storage system through a link, wherein the link is a path from the server to a storage node of a storage system corresponding to the volume.

3. The method according to claim 2, comprising:
when the volume is mapped to the server, mapping the link corresponding to the volume of the storage node to the path device, wherein a quantity of links is the same as a quantity of path devices corresponding to the volume of the storage node.

4. The method according to claim 2, wherein the storage node corresponds to a plurality of path devices, the plurality of path devices are located on the server, wherein the plurality of path devices are aggregated into one multi-path device.

5. The method according to claim 2, wherein the volume is on the storage system, and the volume is divided into a plurality of segments according to a preset segment granularity.

6. The method according to claim 5, wherein a plurality of Input/Outputs form an Input/Output group, a plurality of storage nodes in the Input/Output group are divided into a plurality of mirroring relationships, a quantity of the mirroring relationships is the same as a quantity of the storage nodes in the Input/Output group and a quantity of the segments, and the mirroring relationships correspond to the segments.

7. The method according to claim 5, wherein the step of determining the target storage node and the candidate path device corresponding to the target storage node comprises:
according to a starting position of the new Input/Output, determining a segment corresponding to the new Input/Output;
according to the segment corresponding to the new Input/Output, determining a mirroring relationship corresponding to the segment; and
determining the target storage node through the mirroring relationship corresponding to the segment, to determine the candidate path device corresponding to the target storage node.

8. The method according to claim 1, wherein the unfinished Input/Output size comprises an unfinished Input/Output size existing in the storage node and an Input/Output size when the new Input/Output occurs.

9. The method according to claim 1, wherein types of the storage nodes comprise a master node type, and the step of, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the master node type; and
according to the unfinished Input/Output size and the Input/Output time consumption, fitting a mapping relationship between the unfinished Input/Output size and the Input/Output time consumption of the storage node of the master node type.

10. The method according to claim 1, wherein types of the storage nodes comprise a slave node type, and the step of, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the slave node type; and
according to the unfinished Input/Output size and the Input/Output time consumption, fitting a mapping relationship between the unfinished Input/Output size and the Input/Output time consumption of the storage node of the slave node type.

11. The method according to claim 1, wherein types of the storage nodes comprise an other-node type, and the step of, according to the unfinished Input/Output size and the Input/Output time consumption, fitting the mapping relationship between the unfinished Input/Output size and the Input/Output time consumption of the storage nodes of the various types comprises:
collecting an unfinished Input/Output size and corresponding Input/Output time consumption of a storage node of the other-node type; and
according to the unfinished Input/Output size and the Input/Output time consumption, fitting a mapping relationship between the unfinished Input/Output size and the Input/Output time consumption of the storage node of the other-node type.

12. The method according to claim 1, wherein the mapping relationship is used for calculating the estimated time consumption for sending the new Input/Output from the candidate path device to the target storage node.

13. The method according to claim 1, wherein the step of, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining a master node and a candidate path device corresponding to the master node; and
according to the mapping relationship corresponding to the master node and the candidate path device, calculating estimated time consumption for sending the new Input/Output from the candidate path device to the master node.

14. The method according to claim 1, wherein the step of, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining a slave node and a candidate path device corresponding to the slave node; and
according to the mapping relationship corresponding to the slave node and the candidate path device, calculating estimated time consumption for sending the new Input/Output from the candidate path device to the slave node.

15. The method according to claim 1, wherein the step of, when the new Input/Output occurs, determining the target storage node and the candidate path device corresponding to the target storage node, and according to the mapping relationship corresponding to the target storage node and the candidate path device, calculating the estimated time consumption for sending the new Input/Output from the candidate path device to the target storage node comprises:
when the new Input/Output occurs, determining other nodes and candidate path devices corresponding to the other nodes; and
according to the mapping relationship corresponding to the other nodes and the candidate path device, calculating estimated time consumption for sending the new Input/Output from the candidate path device to the other nodes.

16. The method according to claim 13, wherein the step of comparing the estimated time consumption, and selecting the candidate path device corresponding to the shortest estimated time consumption as the target path device comprises:
comparing the estimated time consumption for sending the new Input/Output from the candidate path device to the master node, estimated time consumption for sending the new Input/Output from the candidate path device to a slave node, and estimated time consumption for sending the new Input/Output from the candidate path devices to other nodes, to obtain the shortest estimated time consumption; and
selecting the candidate path device corresponding to the shortest estimated time consumption as the target path device.

17. The method according to claim 1, wherein after the step of, comparing the estimated time consumption, and selecting the candidate path device corresponding to the shortest estimated time consumption as the target path device, the method further comprises:
sending the new Input/Output to the target storage node through the target path device.

18. (canceled)

19. An electronic device, comprising a processor, a communication interface, a memory, and a communication bus, wherein the processor, the communication interface, and the memory communicate with each other through the communication bus;
the memory is used for storing a computer program; and
the processor is used for, when executing the program stored on the memory, implementing the operations comprising:
for each of path devices, collecting an unfinished Input/Output size and corresponding Input/Output time consumption of storage nodes of various types corresponding to the path device;
according to the unfinished Input/Output size and the Input/Output time consumption, fitting a mapping relationship between the unfinished Input/Output size and the Input/Output time consumption of the storage nodes of the various types;
when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; and
comparing the estimated time consumption, and selecting a candidate path device corresponding to shortest estimated time consumption as a target path device.

20. A non-transitory computer-readable storage medium, storing instructions that, when executed by one or more processors, cause the processors to perform operations comprising:
for each of path devices, collecting an unfinished Input/Output size and corresponding Input/Output time consumption of storage nodes of various types corresponding to the path device;
according to the unfinished Input/Output size and the Input/Output time consumption, fitting a mapping relationship between the unfinished Input/Output size and the Input/Output time consumption of the storage nodes of the various types;
when a new Input/Output occurs, determining a target storage node and a candidate path device corresponding to the target storage node, and according to a mapping relationship corresponding to the target storage node and the candidate path device, calculating estimated time consumption for sending the new Input/Output from the candidate path device to the target storage node; and
comparing the estimated time consumption, and selecting a candidate path device corresponding to shortest estimated time consumption as a target path device.

21. The electronic device according to claim 19, wherein the storage nodes are located on a storage system, and before the operation of, for each of the path devices, collecting the unfinished Input/Output size and the corresponding Input/Output time consumption of the storage nodes of the various types corresponding to the path device, the operations further comprise:
in response to a creation instruction for a server and a volume of the storage node, mapping the volume to the server, wherein the volume is a temporary directory in a lifecycle of the storage node; and
in response to a link creation instruction of the server and the storage system, connecting the server and the storage system through a link, wherein the link is a path from the server to a storage node of a storage system corresponding to the volume.
